(19) United States
(12) Patent Application Publication
(10) Pub. No.: US 2014/0280718 A1
(43) Pub. Date: Sep. 18, 2014

(54) SYSTEM AND METHOD FOR LOCATION AWARE EDUCATIONAL INFORMATION

(71) Applicant: DESIRE2LEARN INCORPORATED, Kitchener (CA)

(72) Inventor: Brian CEPURAN, Kitchener (CA)

(73) Assignee: DESIRE2LEARN INCORPORATED, Kitchener (CA)

(21) Appl. No.: 14/030,189

(22) Filed: Sep. 18, 2013

Related U.S. Application Data
(60) Provisional application No. 61/787,152, filed on Mar. 15, 2013.

(51) Int. Cl. H04L 29/08

(52) U.S. Cl. CPC H04L 67/02
USPC 709/217

(57) ABSTRACT

There is provide a system and method for providing location aware educational information. The method for providing location aware educational information includes: receiving a user location related to a user; receiving user study data related to the user; determining location aware educational information based on the user location and the user study data; and notifying the user about the location aware educational information. The system for providing location aware educational information has: a location module for receiving a user location related to a user; a study area module for receiving user study data related to the user; a location module for determining location aware educational information based on the user location and the user study data; and a connection module for notifying the user of the location aware educational information.

### RELATED APPLICATIONS

This application claims priority to U.S. Provisional Patent Application No. 61/787,152 filed Mar. 15, 2013, which is incorporated herein by reference.

### FIELD

The present disclosure relates generally to educational services. More particularly, the present disclosure relates to providing information about various locations based on user study area and user location.

### BACKGROUND

In formal education, an area of study can be defined by a curriculum. The curriculum outlines the content needed to achieve a particular learning objective. The curriculum may be based on a more general syllabus which specifies what topics must be understood and what level is to be achieved for a particular grade or standard.

In less formal education, individuals may have a specific interest in an area of study and wish to augment their knowledge in this area.

Traditional education has been based on in-class learning with occasional teacher directed field trips. More recently, education has been available via various on-line systems but in a similar manner to in-class learning.

In either of these learning paradigms, the educational process is somewhat limited and restrictive. As such, there is a need for improved systems and methods of providing education information.

### SUMMARY

In a first aspect, the present disclosure provides a method for providing location aware educational information, the method including: receiving a user location related to a user; receiving user study data related to the user; determining location aware educational information based on the user location and the user study data; and notifying the user about the location aware educational information.

In some cases, the user location may be a geographic location of a mobile device of the user.

In some cases, the user study data may be data related to at least one study area that the user is studying.

In some cases, the user study data may include at least one of: user grades, academic goals, user strengths, and user weaknesses.

In some cases, the determining location aware educational information may include: correlating location aware educational information with the user study data that are within a predetermined location range of the user location; and selecting location aware educational information based on user requirements.

In some cases, the user requirements may include user needs based on user study data relating to user weaknesses.

In some cases, the user location may be predicted based on user calendar information.

In some cases, the user location may be a virtual location.

In a further aspect, the present disclosure provides a system for providing location aware educational information, the system including: a location module for receiving a user location related to a user; a study area module for receiving user study data related to the user; a location module for determining location aware educational information based on the user location and the user study data; and a connection module for notifying the user of the location aware educational information.

In some cases, the user study data may include data related to at least one study area that the user is studying.

In some cases, the user study data may include at least one of: user grades, academic goals, user strengths, and user weaknesses.

In some cases, the location module may include: a correlation component configured to correlate the user location and the user study data with location aware educational information in a predetermined range of the user location; and a selection component configured to select location aware education information from among the correlated location aware educational information based on user requirements.

In some cases, the user requirements may include user needs based on user study data relating to user weaknesses.

In some cases, the user location may be predicted based on user calendar information. In other cases, the user location is a virtual location.

In a further aspect, there is provided a non-transitory computer readable medium containing instructions that, when executed, perform a method for providing location aware educational information, the method including: receiving a user location related to a user; receiving user study data related to the user; determining location aware educational information based on the user location and the user study data; and notifying the user about the location aware educational information.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 is a block diagram illustrating some components of a system for location aware educational information;

FIG. 2 is a flowchart illustrating a method for location aware educational information, according to one embodiment;

FIG. 3 is a flowchart of a particular example of using the method for location aware educational information, according to the method of FIG. 2; and

FIG. 4 illustrates an example user device display using the system for location aware educational information.

### DETAILED DESCRIPTION

Generally, the present disclosure provides embodiments of a system and method for providing location aware educational information. The system for location aware educational information is intended to provide predictive, proactive, as well as reactive educational information, and helpful data sources for areas of study that have been identified based at least in part on user study data. For example, a user may be having particular difficulties in a certain area of study, or wish to concentrate his learning in a certain area of study. The user could augment his studying with interactive, directed learning, for example through practical real world experiences or via specific educational information described or detailed in online sources. The interactive directed learning may be pushed to the individual based on the individual's location, for example, his geographical location, his online location, or the like. It will be understood that the term “location” is used in a broad sense that may include where the user is physically or virtually as well as the context of what the user is doing.

FIG. 1 illustrates an embodiment of a system 100 for location aware educational information. The system 100 includes at least one user device 102 which communicates with at least one network device 104 via a network 106. The network 106 may be the Internet, a local area network (LAN), a wide area network (WAN), a personal area network (PAN), an enterprise network, a virtual private network (VPN), or the like.

The user device 102 may be a mobile device or other computing device with network capabilities, for example, portable computers, tablet computers, cellular telephones, handheld computers, personal digital assistants, desktop computers, or the like. The user device 102 may be associated with a user in the system 100 in that the user may be required to login to the system 100, and the system 100 retrieves specific user data from the user device upon logging into the system 100.

The user device 102 includes a processor 108 to process data and instructions from other components of the user device 102 and a memory component 110, for example a database, adapted to store data. The user device 102 further includes a receiver 112 to receive data from the network 106, a transmitter 114 to transmit data over the network 106, a locator module 116 to determine user location data of the user device 102, at least one input component 118, for example a keypad, a keyboard, a mouse, a touch screen or the like and an output component 120, for example a monitor, a screen or the like.

In a specific example, the locator module 116 is a geographically location-aware system such as a GPS device or the like, which determines the user location data through the user's geographical positioning. In another example, the locator module 116 determines the user location data as online location data which may be based on a webpage or website on the user device 102. In some cases, the locator module 116 may be a preexisting module of the user device 102, for example the GPS device of a mobile device, and the system 100 may be adapted to retrieve location data from the preexisting module.

The network device 104 includes a processor 122 for processing data and instructions received from other modules, and a memory component 124, for example at least one database, for storing data. The memory component 124 includes a study area database 126 to store data related to user study area and a location database 128 to store data related to locations. In some cases, the study area database and location database may be a single database. In other cases, the study area database and location database may be operatively linked to the database 110 of the user device 102 in order to retrieve information stored on the user device 102. The memory component 124 may be the memory component for the network device 104 or the system for location aware educational information 100 may include a separate memory component. The processor 122 may be a dedicated or shared processor. In some cases, the system 100 may incorporate a plurality of processors, for example, each module of the system 100 may include at least one processor.

The system 100 and network device 104 further include a connection module 136 configured to send and receive data via the network 106. The system 100 further includes a location module 132, a study area module 140 and a feedback module 138.

The connection module 136 is operatively connected to the study area module 140. The study area module 140 may retrieve user study data from the user device 102 or from the user study data stored in the user study database 126. The user study data may include, for example, that the user is enrolled in a particular area of study (class, course, academic program). The user study data may further include the status of the user in the particular area of study, such as grading information, test results, and areas where the user may wish to have more information. In some cases, the user study data includes user grades, user academic goals, user successes, for example classes or areas where the user excels, and user weakness, for example study areas where the user has done poorly and would benefit from additional information. In other cases, the user study data may include study areas that interest the user or study areas in which the user wishes to be better informed. The user study data may be updated by, for example, user inputs received at the user device 102, information provided by a system administrator or instructor, information retrieved through the system querying user data from the user device, or the like. In particular, the user study database 126 may be part of or operatively connected to a learning management system (not shown), which tracks the user's study information.

The connection module 136 is further connected to the location module 132. The location module 132 is configured to retrieve user location data. The location module 132 may query the locator module 116 of the user device 102 or the locator module 116 may send the user location data to the location module 132 when the user device 102 connects to the system 100. In some cases, the location module 132 is configured to determine or predict a future location of the user. Future location may be determined by checking future location information such as, for example, a calendar or an agenda entry containing details of where the user, and therefore, user device 102, might be located in the future.

The location module 132 is further adapted to retrieve location aware educational information from the location database 128. The location aware educational information relates study areas to locations. For example, in the study of history, the educational information may relate particular topics/study areas to particular locations, such as a physical location, for example, a historic area or site, a monument, a business centre, or the like. Each location can be correlated with study areas through a set of study areas correlated with the educational information. For example, if the location is the Statute of Liberty the set of study areas may be, for example: History, Construction, Immigration, Landmarks and the like.

In some cases, the location aware educational information may be related to an online location, for example a website, and the set of study areas may be related to the information available on the webpage and by following various hyperlinks or webpage links from the website. For example, the online location may be the Wikipedia™ webpage on the Statute of Liberty and the set of study areas may be the same as the study areas of the physical location of the Statute of Liberty, namely the set of study areas: History, Construction, Immigration, Landmarks.

The location module 132 may include a correlation component 130 and a selection component 134. In some cases, the correlation component 130 and selection component 134 may be included in a single module. The correlation component 130 is configured to correlate the user location data, the user study data, and the set of study areas with the location aware educational information. The selection component 134 is adapted to review the correlations provided by the correlation component 130 and select the location aware educational information to display or otherwise provide to the user.

The system for location aware educational information 100 may include a feedback module 138. The feedback module 138 may receive feedback from a user on location aware educational information, the set of study areas related to a location, or the like. The system 100 may have an administrator or may have predetermined guideless to review the feedback. If it is determined that the feedback is relevant and beneficial, the feedback may be saved to the appropriate database. In some cases, the system 100 may include a feedback database (not shown) and all feedback may be stored. A user of the system 100 may review the feedback submitted by other users when the feedback is related to or relevant to a location, study area or location aware educational information the user is currently viewing.

FIG. 2 illustrates an embodiment of a method for providing location aware educational information 200. At 202, the location module 132 of the system 100 determines the user location, which may be a geographical location, for example, the current GPS coordinates or triangulated position of the user's mobile device, or it may be the user's online location, for example, the current webpage the user is reviewing. The system 100 may retrieve the location from the user device 102 or the user device 102 may transmit the user location to the system 100 when the user connects to the system 100. In some cases, the user device 102 may periodically send updates of the user location to the system 100, for example, when the user location changes. The system 100 may retrieve updates regarding the user location at predetermined time intervals or through a continuous feed by the user device 102.

At 204, the study area module 140 of the system 100 further retrieves user study data related to the user. The user study data may be stored in the memory component 124 of the network device 104 or may be retrieved from the user device 102. The user study data may detail the study areas of interest to the user, the study areas of courses in which the user is currently enrolled, or other user study data. The retrieval of the user location and the user study data may be done simultaneously or subsequently depending on how the system 100 is configured to query the user device 102 and the memory component 124 of the system 100.

At 206, the user location and user study data are then correlated by the correlation component 130. The user location is correlated with the user study data in order for the system 100 to determine location aware educational information of interest to the user within a predetermined range of the user location. In some cases, where the user location is a geographical location, the correlation may include a predetermined distance to determine a user location range. In other cases, where the user location is an online location, the correlation may include a predetermined number of hyperlinks or webpages to determine the user location range or may include a correlation between the topic of the webpage the user is viewing and a related webpage for a similar topic.

At 208, the selection component 134 reviews location aware educational information that is available based on the correlation and determines a set of location aware educational information that is appropriate for the user. For example, the selection component 134 may determine whether notifying the user of the location aware educational information within the user location range would help increase the user's knowledge in the at least one study area of interest to the user. In some cases, the selection component 134 reviews the user study data to determine if the user has user weakness in a study area in the set of study areas relevant to the location aware educational information.

At 210, the selection component 134 will select one or more of the location aware education information from the set of appropriate location aware educational information retrieved by the system 100. The selection component 134 may also determine whether the user has previously received the educational information. If so, the location module 132 may determine that particular location aware educational information should not be sent to user again.

At 212, the user is notified 212 of at least one location aware educational information. In some cases, the user may be notified of a plurality of location aware educational information for the user to review and select to determine if there is one the user would like to pursue.

The location aware educational information may include, for example, the geographic location, for example an address, directions from the location of the user device 102 to the location, the significance of the location in relation to at least one study area, or the like. The user device 102 communicates the location aware educational information to the user, for example displaying the information on a screen or monitor, which is intended to increase the user's knowledge in that study area.

FIG. 3 illustrates a more detailed embodiment of a method for providing location aware educational information 300. In this embodiment, at 302, the system 100 retrieves the user location as a geographical location, in this case, 123 Boulevard Road, Capitol City, State, U.S.A. The system 100 may store this geographical location in the memory component 124 of the network device 104.

At 304, the system 100 further retrieves the user study data. The user study data includes the user course information, for example History 101 and Political Science 102, the curriculum of the courses in question, a measure of the user's weaknesses, for example, the user is performing poorly (i.e. marks below a threshold, either a predetermined threshold or in relation to other user marks or marks of others in the same course, or the like) in Political Science, and study areas the user has selected as an interest.

At 306, the correlation module 130 correlates the user location and the user study data. In this example, the user has a predetermined location range of less than 25 km with preference to locations less than 10 km from the user location. Locations that are too far from the user's location 102 are not selectable. Locations within this location range are selectable. The set of predetermined study areas for the selectable locations are reviewed and the location aware educational information on selectable locations that contain study areas correlated with the user study data are prepared as selectable locations for the user.

At 308, the selection module 134 determines the location aware educational information that is relevant to the selectable locations. At 310, the selection module 134 further selects if there is educational information that is not desirable to the user. For example, the user may have already recently received the selectable educational information or the user may have indicated that he or she does not wish to receive educational information for a specific reason. The selection module 134 may also determine a ranking or order for the relevant educational information and may notify the user if any of the relevant education information is of particular importance to any of the user study data. For example, location A may be a particularly good example of 1920s architecture in that it showcases a specific style popularized during that era.

In this example, the relevant location aware educational information was information related to locations A, B, X and Y. It was further determined that location X had been previously sent to the user. The selection module 134 selects location aware educational information related to locations A, B and Y.

At 312, the connection module 136 receives the selected information and sends notifications relating to location A, B and Y to the user. The information relating to location A, B, and Y may include the proximity of each location to the user device 102. Additionally, the user device 102 may be configured to display further educational information about the locations A, B and Y, such as the address or directions to the location, the significance of each location in relation to the user study data, or the like. This additional information may be displayed either automatically or based on user selection.

In a specific example, if the user is taking a course on the Canadian federal government and is having difficulty in identifying buildings and if the user is in the Ottawa area the user may be notified that Parliament Hill is nearby or may be directed to a specific building on Parliament Hill. The user can then go to the location and get a first-hand view of the buildings in relation to the Canadian federal government.

FIG. 4 illustrates an example of a display 400 on a user device 102 using the system 100 to provide location aware educational information. In the example, the user may be located in Washington D.C. and may currently be enrolled in History, Political Science and Architecture courses. When the user device 102 is within a predetermined distance from a location, the system 100 may display a picture or representation of a selected location that correlates to the user location and the user study data. In this case, the system 100 may display a representation 402 of the White House. As the White House may be associated with a set of study areas, the system may provide the user with a selection option, for example buttons 404, a drop down list, or the like. The user is then able to select what educational information the user would like to review and the user is able to review educational information on multiple study areas as the information relates to the selected location. In some cases, the user may be presented with the educational information without having any selection options.

The user may also be presented with a button 406 or other selection option where the user may view other correlated locations and location aware educational information. For example, the user selects button 406 and receives information about other locations within the user's location range that are correlated with the user's study data.

The display may further contain a feedback option 408. The user may view previous users' feedback on the location aware educational information and may enter the user's own feedback. The feedback may then be saved by the feedback module 138 and may be displayed to other users who review the feedback.

In a specific example, the user location may be associated with a webpage or website instead of a geographical location. The system 100 monitors the user's browsing and may retrieve user study data and correlate the user study data with the user location. The system 100 may further review a webpage to determine a set of study areas relevant to the webpage and to the links provided by the webpage. The system 100 may further select relevant location aware educational information based on a set of study areas. The user is sent a notification that there is relevant content for further review. The system 100 may present this information by highlight text or links within the webpage or by otherwise directing the user's attention to the relevant location aware educational information. In some cases, the method includes crawling the webpage and linked webpages or websites to identify at least one link that includes relevant educational information.

In a further example, the system uses virtual proximity and a learning network to determine a distance between nodes and paths in the learning network to define a location space that can be used to suggest people, content, and objectives that are correlated to the user location and the user's study area.

In another further example, a user may have a plurality of user devices associated with user study data. In some cases, a notification of location aware educational information may be limited to a specific user device. User devices that are stationary for a predetermined period of time may not be sent notifications; unless a user selection is received activating the user device for a period of time. In other cases, the notification of location aware educational information may be sent to the plurality of user devices. In still other cases, the notification may be sent to the user devices within a same user location while user devices outside that location will not receive notifications.

In yet another further example, a user location may be determined as a future location and the system may predict the user location. In some cases, the system 100 may predict the user's location by reviewing upcoming calendar appointments. If an upcoming calendar appointment specifies a location, the system 100 may correlate the appointment location with the user study data to determine location aware educational information that will be relevant to the user once the user has reached that appointment location. In other cases, the system 100 may predict the user's location through the movement of the user device 102. For example, if the system determines the user is travelling in a certain direction and at a certain speed the system may predict the destination of the user. The predicted destination could be correlated with the user study data and the user may be informed of educational information relevant to the destination of the user. In some cases, the predicted destination may be updated continuously or at predetermined intervals as the user continues travelling such that the system 100 provides location aware educational information along the route being taken.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A method for providing location aware educational information, the method comprising:
receiving a user location related to a user;
receiving user study data related to the user;
determining location aware educational information based on the user location and the user study data; and
notifying the user about the location aware educational information.

2. The method of claim 1, wherein the user location comprises a geographic location of a mobile device of the user.

3. The method of claim 1, wherein the user study data comprises data related to at least one study area that the user is studying.

4. The method of claim 3, wherein the user study data comprises at least one of: user grades, academic goals, user strengths, and user weaknesses.

5. The method of claim 1, wherein the determining location aware educational information comprises:
correlating location aware educational information with the user study data that are within a predetermined location range of the user location; and
selecting location aware educational information based on user requirements.

6. The method of claim 5, wherein the user requirements comprise user needs based on user study data relating to user weaknesses.

7. The method of claim 1, wherein the user location is predicted based on user calendar information.

8. The method of claim 1, wherein the user location is a virtual location.

9. A system for providing location aware educational information, the system comprising:
a location module for receiving a user location related to a user;
a study area module for receiving user study data related to the user;
a location module for determining location aware educational information based on the user location and the user study data; and
a connection module for notifying the user of the location aware educational information.

10. The system of claim 9, wherein the user location comprises a geographic location of a mobile device of the user.

11. The system of claim 9, wherein the user study data comprises data related to at least one study area that the user is studying.

12. The system of claim 11, wherein the user study data comprises at least one of: user grades, academic goals, user strengths, and user weaknesses.

13. The system of claim 9, wherein the location module comprises:
a correlation component configured to correlate the user location and the user study data with location aware educational information in a predetermined range of the user location; and
a selection component configured to select location aware education information from among the correlated location aware educational information based on user requirements.

14. The system of claim 13, wherein the user requirements comprise user needs based on user study data relating to user weaknesses.

15. The system of claim 8, wherein the user location is predicted based on user calendar information.

16. The system of claim 8, wherein the user location is a virtual location.

17. A non-transitory computer readable medium containing instructions that, when executed, perform the method of claim 1.
